(19) United States
(12) Patent Application Publication
(10) Pub. No.: US 2021/0034771 A1
(43) Pub. Date: Feb. 4, 2021

(54) INFORMATION PROCESSING SYSTEM, INFORMATION PROCESSING APPARATUS, USER AUTHENTICATION METHOD AND NON-TRANSITORY RECORDING MEDIUM

(71) Applicant: Hodaka WATANABE, Kanagawa (JP)

(72) Inventor: Hodaka WATANABE, Kanagawa (JP)

(21) Appl. No.: 16/920,940

(22) Filed: Jul. 6, 2020

(30) Foreign Application Priority Data
Jul. 31, 2019 (JP) 2019-141582

(51) Int. Cl. G06F 21/60; G06F 21/44; G06F 21/31; G06F 3/12

(52) U.S. Cl. CPC G06F 21/608; G06F 3/1222; G06F 21/31; G06F 21/44

(57) ABSTRACT

An information processing system, an information processing apparatus, a user authentication method, and a non-transitory recording medium. The information processing system receives input of identification information and authentication information of a user, makes an authentication request to an authentication apparatus, and in response to a failure in authentication by the authentication apparatus, transmits to one or more terminals, the identification information and an inquiry asking whether each terminal of the one or more terminals stores identification information that matches the identification information input by the user.

### CROSS-REFERENCE TO RELATED APPLICATIONS

This patent application is based on and claims priority pursuant to 35 U.S.C. § 119(a) to Japanese Patent Application No. 2019-141582, filed on Jul. 31, 2019, in the Japan Patent Office, the entire disclosure of which is hereby incorporated by reference herein.

### BACKGROUND

### Technical Field

The present disclosure relates to an information processing system, an information processing apparatus, a user authentication method, and a non-transitory recording medium.

### Background Art

A pull print system transmits print data related to a print job from a terminal to an image forming apparatus such as a multi-function peripheral (MFP) through a server to execute printing. In the pull print system, a user logs in to the system from the MFP, establishes communication and executes a desired print job stored in the server, the terminal, or the like.

In the network system such as the pull print system as described above, various login techniques have been proposed which improve the convenience of the user.

### SUMMARY

Embodiments of the present disclosure describe an information processing system, an information processing apparatus, a user authentication method, and a non-transitory recording medium. The information processing system receives input of identification information and authentication information of a user, makes an authentication request to an authentication apparatus and in response to a failure in authentication by the authentication apparatus, transmit to one or more terminals, the identification information and an inquiry asking whether each terminal of the one or more terminals stores identification information that matches the identification information input by the user.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a schematic diagram illustrating a hardware configuration of a printing system in embodiments of the present disclosure;

FIG. 2A and FIG. 2B are block diagrams illustrating a hardware configuration of each device included in the printing system according to embodiments of the present disclosure;

FIG. 3 is a block diagram illustrating a functional configuration of the printing system according to a first embodiment of the present disclosure;

FIG. 4 is a diagram illustrating an example of an authentication process executed by the printing system according to the first embodiment of the present disclosure;

FIG. 5 is a flowchart illustrating a pull print process executed by an image forming apparatus according to the first embodiment of the present disclosure;

FIG. 6 is a flowchart illustrating an authentication process executed by the printing system according to a second embodiment of the present disclosure;

FIG. 7 is a block diagram illustrating a functional configuration of the printing system according to a third embodiment of the present disclosure; and

FIG. 8 is a diagram illustrating an example of an authentication process executed by the printing system according to the third embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result. As used herein, the singular forms “a”, “an”, and “the” are intended to include the plural forms as well, unless the context clearly indicates otherwise.

The present disclosure is not limited to the details of the example embodiments described below, and various modifications and improvements are possible. In the drawings for describing the following embodiments, the same reference numbers are allocated to elements (members or components) having the same function or shape and redundant descriptions thereof are omitted below.

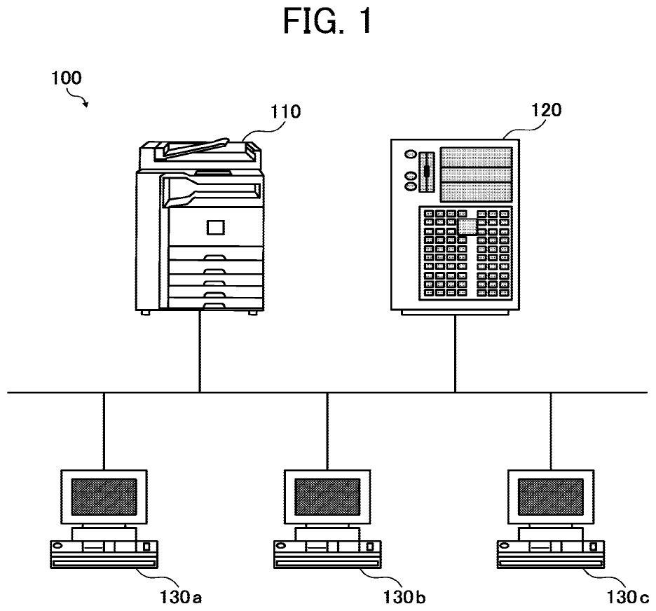

FIG. 1 is a schematic diagram illustrating a hardware configuration of a printing system 100 in embodiments of the present disclosure. FIG. 1 illustrates, as an example, the printing system 100 in an environment in which an image forming apparatus 110, a server 120, and a client terminal 130 are connected through a network such as the Internet or a local area network (LAN). The numbers of the image forming apparatuses 110, the server 120, and the client terminals 130 are not limited to the numbers illustrated in FIG. 1, and the number of apparatuses included in the printing system 100 is not particularly limited. The method of connecting from each apparatus to the network may be wired or wireless.

The image forming apparatus 110 is a multifunction peripheral including various functions such as copy, scan, facsimile transmission and reception, and file transfer. In the present embodiment, the image forming apparatus 110 executes a pull print process by logging in to the printing system 100 and executing the process based on the print job received from the server 120 or the client terminal 130.

The server 120 is an information processing apparatus configured to provide various services for implementing the printing system 100 of each embodiment. The server 120 executes various functions such as management of each apparatus included in the printing system 100, management of various data such as user information and print jobs, and authentication of a user who has logged in to the printing system 100 from the image forming apparatus 110. Note that FIG. 1 illustrates the printing system 100 configured to execute the above-described functions by one server 120, but the embodiment is not particularly limited, and a plurality of servers 120 having the respective functions may be included in the printing system 100.

The client terminal 130 is, for example, an information processing apparatus such as a personal computer. The client terminal 130 generates a print job including image data to be printed and various settings data regarding printing. Various data generated by the client terminal 130 is transmitted to the server 120. In addition, the client terminal 130 stores the generated data and transmit the data to the image forming apparatus 110 in response to a request from the image forming apparatus 110 that has logged in to the printing system 100.

In the embodiments described below, the printing system 100 having a configuration in which the image forming apparatus 110 authenticates when the server 120 cannot authenticate is described as an example, but the embodiment is not particularly limited to this example. For example, an information processing apparatus other than the image forming apparatus 110 may perform the authentication.

Further, in the present embodiment, a system in which a print job is stored in the server 120 and printing by the pull print method is described, but the embodiment is not particularly limited. For example, the server 120 may perform a user authentication process exclusively, and the image forming apparatus 110 may directly acquire a print job from the client terminal 130 (serverless pull print system).

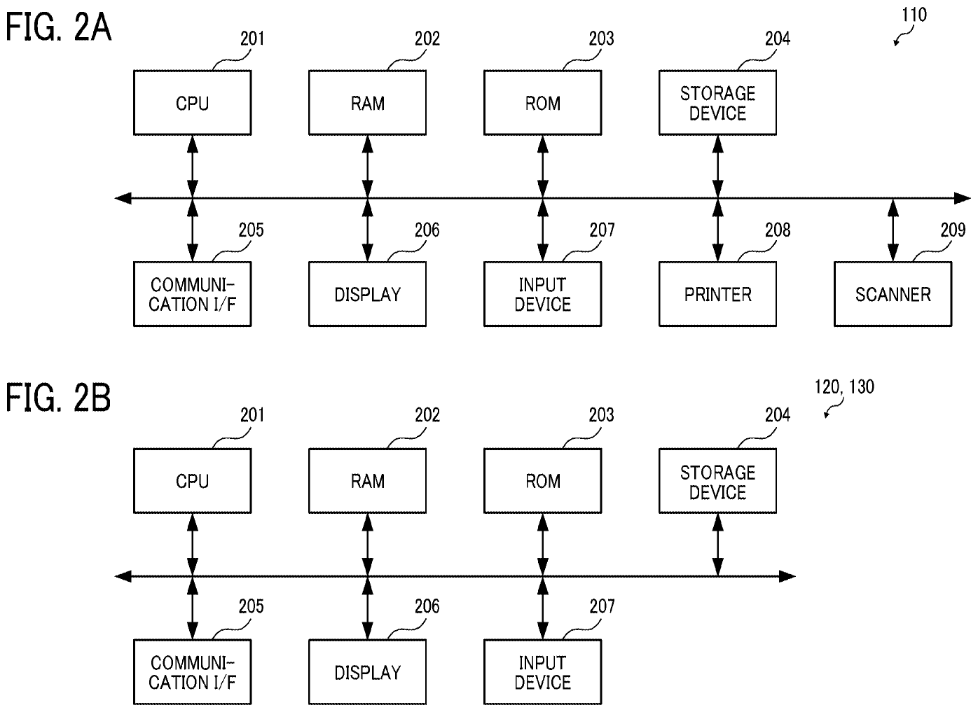

A hardware configuration of each device of embodiments of the present disclosure is described. FIG. 2A and FIG. 2B are block diagrams illustrating the hardware configuration of respective devices included in the printing system 100 according to embodiments of the present disclosure. FIG. 2A illustrates an example of the hardware configuration of the image forming apparatus 110 and FIG. 2B illustrates an example of the hardware configuration of the server 120 and the client terminal 130.

As illustrated in FIG. 2A, the image forming apparatus 110 according to the present embodiment includes a central processing unit (CPU) 201, a random access memory (RAM) 202, a read only memory (ROM) 203, a storage device 204, a communication interface (I/F) 205, a display 206, an input device 207, a printer 208, and a scanner 209 connected to each other through a bus.

The CPU 201 is a device configured to execute a program that controls the operation of the image forming apparatus 110 and performs processing. The RAM 202 is a volatile storage device that provides an area for deploying programs executed by the CPU 201 and is used for storing and expanding programs and data. The ROM 203 is a non-volatile storage device for storing programs and firmware executed by the CPU 201.

The storage device 204 is a readable/writable non-volatile storage device configured to store an operating system (OS) that causes the image forming apparatus 110 to function, various applications, settings information, various data, and the like. Examples of the storage device 204 include a hard disk drive (HDD) and a solid state drive (SSD).

The communication I/F 205 connects the image forming apparatus 110 to a network and enables communication with other apparatuses through the network. The communication through the network may be wired communication or wireless communication and various data are transmitted and received using a communication protocol such as Transmission Control Protocol/Internet Protocol (TCP/IP).

The display 206 is a device configured to display various data, a status of the image forming apparatus 110, and the like to the user, and is implemented by a liquid crystal display (LCD) or the like as an example. The input device 207 is a device for the user to operate the image forming apparatus 110, and examples thereof include a plurality of buttons to which various operations are assigned. The display 206 and the input device 207 may be separate devices or a single device having both functions such as a touch panel display.

The printer 208 is a device configured to form an image on a sheet by a laser method, an inkjet method, or the like. The scanner 209 is a device configured to read an image of a printed matter and convert the image into data. For example, the image forming apparatus 110 copies a printed material in cooperation with the scanner 209 and the printer 208. Further, for example, the image forming apparatus 110 implements a facsimile function by in cooperation with the communication I/F 205, and the scanner 209 or the printer 208.

Next, a hardware configuration of each of the server 120 and the client terminal 130 is described. As illustrated in FIG. 2B, the server 120 and the client terminal 130 according to the present embodiment each include a CPU 201, a RAM 202, a ROM 203, a storage device 204, a communication I/F 205, a display 206, and an input device 207 connected to each other through a bus. Since the hardware included in each of the server 120 and the client terminal 130 has a configuration similar to the hardware included in the image forming apparatus 110, detailed description thereof is omitted. The server 120 may not include the display 206 or the input device 207.

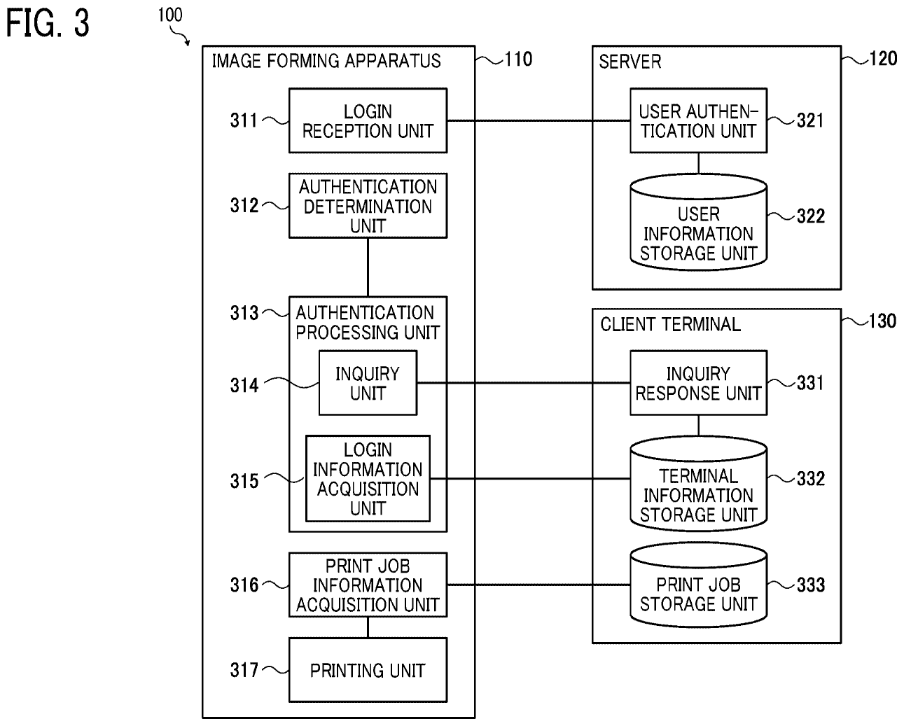

The hardware configuration of each device included in the printing system 100 according to embodiments of the present disclosure has been described above. In the following, the first embodiment is described first as a detailed description for each embodiment. First, functions implemented by each hardware in the first embodiment is described with reference to FIG. 3. FIG. 3 is a block diagram illustrating a functional configuration of the printing system 100 according to the first embodiment of the present disclosure.

The image forming apparatus 110 included in the printing system 100 according to the first embodiment includes a login reception unit 311, an authentication determination unit 312, an authentication processing unit 313, a print job information acquisition unit 316, and a printing unit 317.

The login reception unit 311 receives a login to the printing system 100 by a user's operation for the user to execute the pull print process. The login reception unit 311 receives input of login information such as an identifier (ID) and a password from the user. The ID is identification information for uniquely identifying the user and is assigned to each user in advance. The password is authentication information associated with the ID and used to authenticate the user to whom the ID is assigned. The login reception unit 311 transmits the ID and password input by the user to the server 120 that is an authentication apparatus, and requests user authentication. The login may be accepted by the integrated circuit (IC) card owned by the user.

The authentication determination unit 312 determines whether the server 120 has authenticated a user or not. The authentication determination unit 312 determines the authentication by the server 120 based on the communication state with the server 120. Examples of causes of authentication failure by the server 120 include timeout due to concentration of access, interruption of communication due to an unstable communication environment, malfunction or error of the server 120, and the like.

The authentication processing unit 313 executes an authentication process instead of the authentication unit of the server 120 when the authentication determination unit 312 determines that the server 120 cannot execute authentication. The authentication processing unit 313 includes an inquiry unit 314 and a login information acquisition unit 315 The inquiry unit 314 transmits the ID input by the user to each client terminal 130 included in the printing system 100 and inquires whether the client terminal 130 has an ID that matches the ID input by the user. The login information acquisition unit 315 acquires login information such as authentication information from the client terminal 130 that responded to the inquiry by the inquiry unit 314. (Hereinafter, the client terminal 130 having an ID that matches the ID input by the user, that is, the client terminal 130 that has responded to the inquiry may be referred to as a “user terminal 130a” or a “response terminal”). The login information acquisition unit 315 may acquire the internet protocol (IP) address of the user terminal 130a and the like in addition to the authentication information. When the login information acquisition unit 315 acquires the authentication information, the authentication processing unit 313 authenticates the user based on the authentication information. In addition, since the login information acquisition unit 315 acquires an internet protocol (IP) address of the user terminal 130a, communication is established between the user terminal 130a and the image forming apparatus 110 after user authentication.

The print job information acquisition unit 316 acquires various data regarding a print job from the server 120, the client terminal 130, or the like after the user is authenticated and logged in to the printing system 100. For example, when the authentication determination unit 312 determines that the authentication by the server 120 is successful, the print job information acquisition unit 316 acquires the print job list and the like from the server 120. On the other hand, when the authentication determination unit 312 determines that the authentication by the server 120 cannot be executed, the print job information acquisition unit 316 acquires the print job list from the user terminal 130a or the print data related to the print job selected by the user.

The printing unit 317 controls the printer 208 based on the print data acquired by the print job information acquisition unit 316 and forms an image on a sheet material to perform printing.

Next, a description is given of functions of the server 120. The server 120 included in the printing system 100 according to the first embodiment includes a user authentication unit 321 and a user information storage unit 322.

The user authentication unit 321 receives an authentication request from the image forming apparatus 110 and refers to the user information storage unit 322 to execute user authentication.

The user information storage unit 322 controls the storage device 204 of the server 120 and stores various information regarding the user who uses the printing system 100. The user information storage unit 322 stores, for example, a user name, an ID, a password, an IP address of the client terminal 130 used by the user, a print job, and the like.

Next, a description is given of functions of the client terminal 130. The client terminal 130 included in the printing system 100 according to the first embodiment includes an inquiry response unit 331, a terminal information storage unit 332, and a print job storage unit 333.

The inquiry response unit 331 responds to an inquiry from the inquiry unit 314 of the image forming apparatus 110. When the ID transmitted from the inquiry unit 314 and the ID stored in the terminal information storage unit 332 match, the inquiry response unit 331 transmits the authentication information stored in the terminal information storage unit 332 to the image forming apparatus 110. As a result, the image forming apparatus 110 authenticates the user.

The terminal information storage unit 332 controls the storage device 204 of the client terminal 130 and stores various information regarding the client terminal 130. For example, the terminal information storage unit 332 stores the user name of the client terminal 130, the ID and password of the user, the IP address of the client terminal 130, and the like.

The print job storage unit 333 controls the storage device 204 of the client terminal 130 and stores a print job generated by a printer driver or the like.

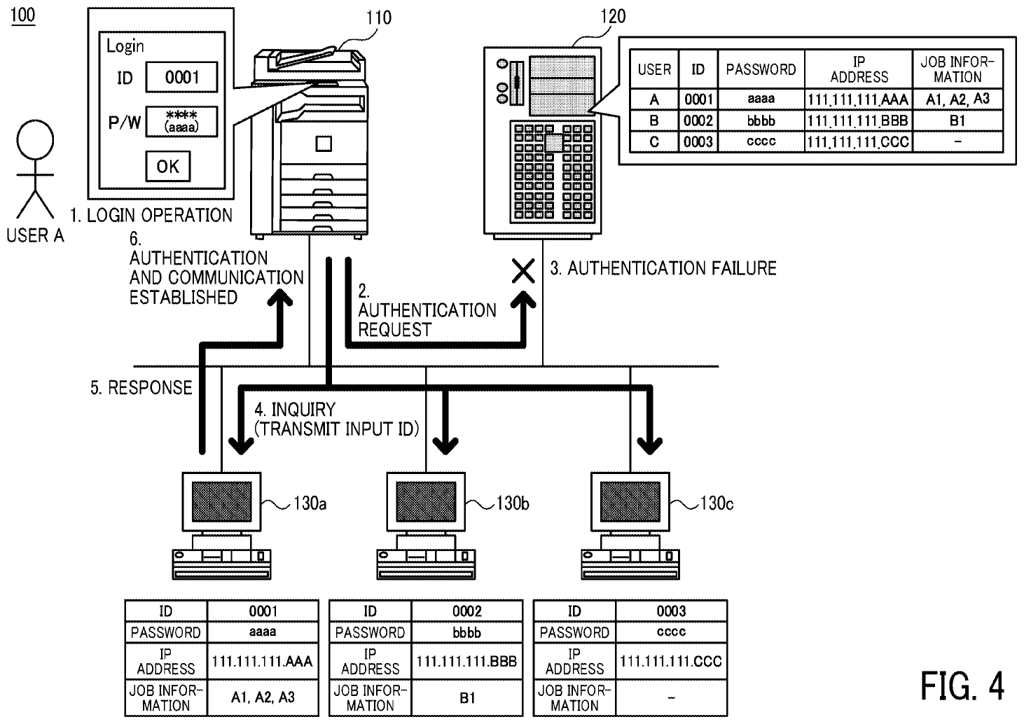

Next, an authentication process executed in the first embodiment is described. FIG. 4 is a diagram illustrating an example of the authentication process executed by the printing system 100 according to the first embodiment. The numbers in FIG. 4 indicate the order of processing.

The printing system 100 according to the first embodiment includes, as illustrated in FIG. 4, the image forming apparatus 110 configured to print by the pull print method, the server 120 configured to authenticate a user, and a plurality of client terminals 130. Hereinafter, a case where a user A operating the image forming apparatus 110 in order to print a file created by the user terminal 130a is described as an example.

The user A instructs the client terminal 130 to create a file to be printed and send the print job to the server 120 through the printer driver. Since the print job is transmitted to the server 120 from the client terminal 130 that has logged in to the printing system 100, each client terminal 130 stores login information such as an ID and a password related to a user who uses the client terminal 130. Further, each client terminal 130 stores the IP address, the job information transmitted to the server 120, and the like together with the login information and the like. Hereinafter, the client terminal 130 used by the user A is referred to as a user terminal 130a, and the client terminals 130 used by users other than the user A is referred to as other user terminals 130b and 130c.

When the user A instructs to transmit a print job from the user terminal 130a to the server 120, the server 120 stores the job information related to the received print job in association with various user information such as the user name. As a result, the user A can log in to the printing system 100 from the image forming apparatus 110, access the server 120, and execute the pull print process.

After transmitting the print job from the user terminal 130a, the user A inputs an ID and a password to the image forming apparatus 110 as a login operation (Number 1). The image forming apparatus 110 receives the login operation of the user A and requests the server 120 for authentication (Number 2).

When the image forming apparatus 110 fails to make an authentication request to the server 120 due to various reasons such as a communication failure, the server 120 does not respond to the image forming apparatus 110 for authentication, and the authentication determination unit 312 of the image forming apparatus 110 determines that the authentication has failed (Number 3). If the authentication is unsuccessful, the user cannot log in to the printing system 100 to execute the pull print process. Alternatively, the image forming apparatus 110 according to the first embodiment executes the authentication process instead of the server 120.

As described above, when the authentication determination unit 312 determines that the authentication has failed (Number 3), the authentication processing unit 313 of the image forming apparatus 110 starts the authentication process. In the authentication process executed by the image forming apparatus 110, the inquiry unit 314 first makes an inquiry to a plurality of client terminals 130 included in the printing system 100 (Number 4). Specifically, the inquiry unit 314 transmits the ID input by the user A during the login operation to the plurality of client terminals 130. In the example illustrated in FIG. 4, the inquiry unit 314 sends the user A′s ID “0001” to the user terminal 130a and the other user terminals 130b and 130c.

When the plurality of client terminals 130 included in the printing system 100 receive the ID from the image forming apparatus 110, the inquiry response unit 331 of each client terminal 130 refers to ID in the storage area of the terminal information storage unit 332. Then, at each client terminal 130, the inquiry response unit 331 compares the received ID with the ID stored in the terminal information storage unit 332, and if IDs match, responds to the image forming apparatus 110 (Number 5). When the received ID matches with the ID stored in the terminal information storage unit 332, the inquiry response unit 331 transmits the password corresponding to the ID to the image forming apparatus 110.

In the example illustrated in FIG. 4, the user terminal 130a of the plurality of client terminals 130 stores the user A′s ID “0001” in the terminal information storage unit 332. Therefore, the user terminal 130a transmits the password “aaaa” for the user A to log in to the image forming apparatus 110. On the other hand, the ID “0001” is not stored in the terminal information storage unit 332 of the other user terminals 130b and 130c of the plurality of client terminals 130. Accordingly, the inquiry response units 331 of the other user terminals 130b and 130c do not respond to the inquiry from the image forming apparatus 110.

As a result, when the user terminal 130a responds to the inquiry from the image forming apparatus 110 and the image forming apparatus 110 receives the password, the authentication processing unit 313 checks the password accepted by the login operation and the user can be authenticated (Number 6). Therefore, even when communication with the server 120 is broken, the image forming apparatus 110 can authenticate the user, and the user can log in to the printing system 100.

Note that the inquiry response unit 331 of the user terminal 130a transmits not only the authentication information but also the IP address of the own device stored in the terminal information storage unit 332 when responding to the image forming apparatus 110. By acquiring the IP address of the user terminal 130a, the image forming apparatus 110 establishes communication between the image forming apparatus 110 and the user terminal 130a after the user is authenticated (Number 6). Accordingly, the image forming apparatus 110 can acquire various types of information related to a print job and execute the print process, even when communication with the server 120 is broken.

Further, in order to improve the security of the printing system 100, communication such as inquiry (Number 4) and response (Number 5) may be performed by applying various encryption techniques. For example, the inquiry unit 314 of the image forming apparatus 110 may be configured to transmit a public key together with the input ID when making the inquiry to each client terminal 130. On the other hand, the user terminal 130a encrypts and transmits the password with the public key. The image forming apparatus 110 that has received the encrypted password can reduce the risk of leakage of the password and improve security of the printing system 100 by decrypting the password using the private key corresponding to the transmitted public key.

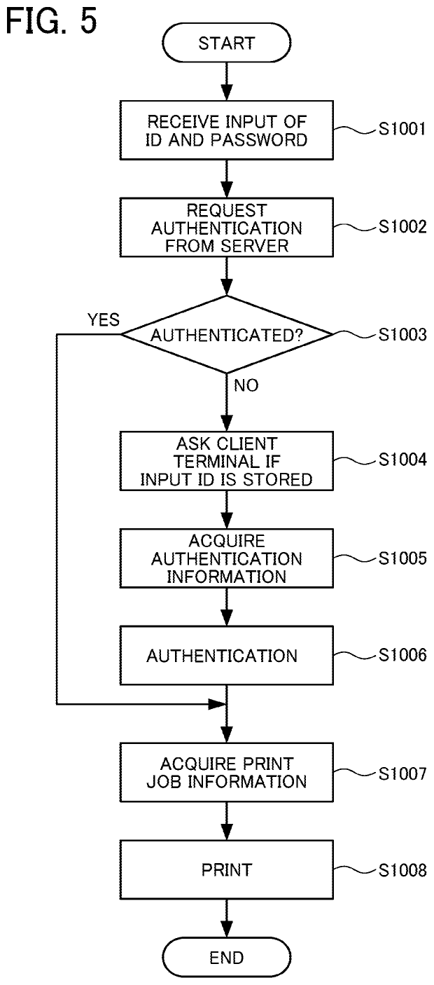

Next, the pull print process executed by the image forming apparatus 110 is described with reference to FIG. 5. FIG. 5 is a flowchart illustrating the pull print process executed by the image forming apparatus 110 according to the first embodiment of the present disclosure. The image forming apparatus 110 starts the process from step S1000.

In step S1001, the login reception unit 311 receives input of the ID and the password from the user. In step S1002, the login reception unit 311 transmits the input ID and password to the server 120 and makes a user authentication request.

In step S1003, the authentication determination unit 312 determines whether or not the server 120 has authenticated the user. Hereinafter, a case where the authentication is successful in step S1003 and a case where the authentication failed are described separately.

If the authentication is successful (YES in step S1003), the process proceeds to step S1007. In step S1007, the print job information acquisition unit 316 acquires information about the print job stored in the server 120. In the case of the serverless print system, the print job information acquisition unit 316 acquires information about the print job stored in the user terminal 130a. The print job information acquisition unit 316 acquires the job name of the print job, for example, and displays a print job list on the display 206. The user selects a desired print job from the displayed print job list. Then, the print job information acquisition unit 316 acquires the print data related to the selected print job.

Next, in step S1008, the printing unit 317 controls the printer 208 to execute a printing process based on the acquired print data. When printing is completed, the image forming apparatus 110 ends the pull print process.

On the other hand, if the authentication failed due to a communication failure or the like (NO in step S1003), the process proceeds to step S1004. Note that when it is determined in step S1003 that the authentication failed, the user may be prompted to confirm the ID or password, and the input may be requested again. Further, the input of the ID or the password may be requested again if the authentication failed due to a reason other than the communication failure, for example, an input error of the ID or the password.

In step S1004, the inquiry unit 314 transmits the input ID to each client terminal 130 and inquires whether the client terminal 130 stores the ID. In step S1005, the login information acquisition unit 315 acquires authentication information (password) from the user terminal 130a that responded to the inquiry in step S1004. In step S1006, the authentication processing unit 313 authenticates the user based on the password input in step S1001 and the password acquired in step S1005.

If the user is authenticated, the user logs in to the printing system 100. Further, when the authentication information is acquired in step S1005, the IP address of the user terminal 130a is also acquired, and communication is established between the image forming apparatus 110 and the user terminal 130a. As a result, the image forming apparatus 110 communicates with the user terminal 130a without going through the server 120 and acquires a print job or the like.

In step S1007, the print job information acquisition unit 316 acquires information about the print job stored in the user terminal 130a. As described above, the print job information acquisition unit 316 acquires the job name of the print job and displays the print job list. The user selects the desired print job from the displayed print job list. Then, the print job information acquisition unit 316 acquires the print data related to the selected print job from the user terminal 130a.

In step S1008, the printing unit 317 controls the printer 208 to execute the print process based on the acquired print data. When printing is completed, the image forming apparatus 110 ends the pull print process.

By the process described above, the image forming apparatus 110 can authenticate the user even when a problem occurs in the communication environment with the server 120. Further, the image forming apparatus 110 can acquire the print data related to the print job from the user terminal 130a and can execute the pull print process.

In the example of the above-described embodiment, the image forming apparatus makes an inquiry when the login from the image forming apparatus 110 fails due to communication failure with the server 120. In the case of the printing system 100 including a large number of image forming apparatuses 110, a plurality of users may perform authentication at the same time. In such a case, if the failure occurs in the communication between the image forming apparatus 110 and the server 120, each image forming apparatus 110 simultaneously makes an inquiry to each client terminal 130, and the access to the network is concentrated causing further deterioration to the communication environment.

In a second embodiment, in the printing system 100 including the plurality of image forming apparatuses 110, the image forming apparatus 110 having inquiry authority (hereinafter referred to as a “root image forming apparatus 110R”) is set in advance. The root image forming apparatus 110R may be configured to make an inquiry to each client terminal 130. As a result, load on the network may be reduced.

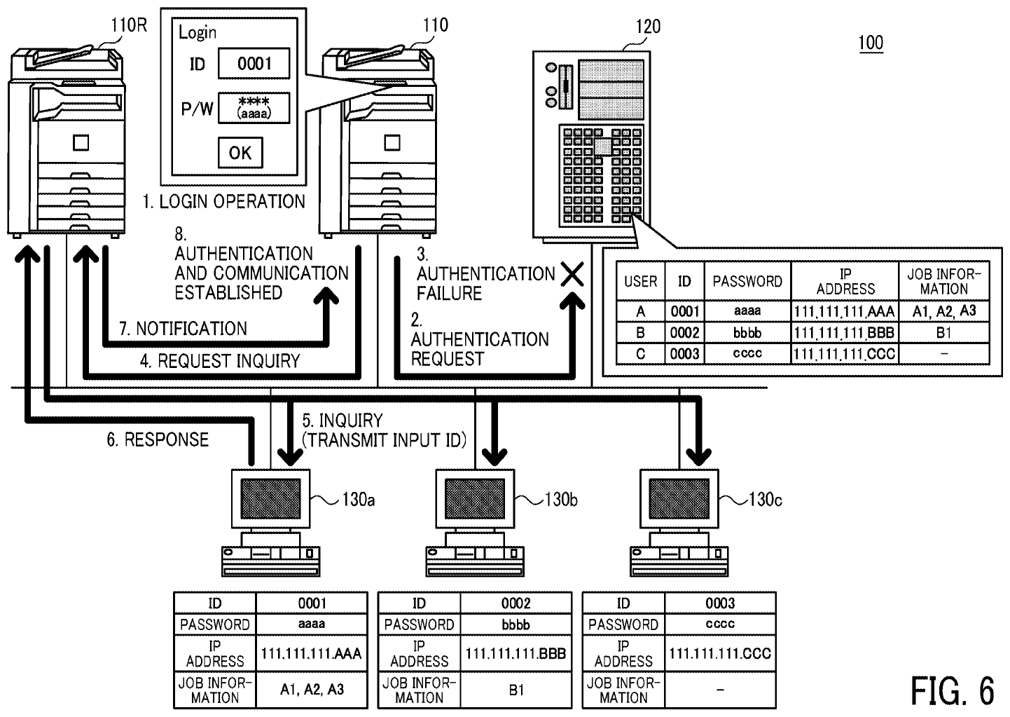

Hereinafter, an authentication process in the second embodiment is described. FIG. 6 is a flowchart illustrating an authentication process executed by the printing system 100 according to the second embodiment of the present disclosure. The numbers in FIG. 6 indicate the order of processing. Further, in FIG. 6, description of items common to the first embodiment described in FIG. 4 is omitted.

As illustrated in FIG. 6, the printing system 100 according to the second embodiment includes a plurality of image forming apparatuses 110 configured to execute printing by the pull print method, the server 120 configured to authenticate a user, and a plurality of client terminals 130. Further, one of the plurality of image forming apparatuses 110 illustrated in FIG. 6 is the root image forming apparatus 110R having inquiry authority. In the following, a case where the user A operates the image forming apparatus 110 having no inquiry authority to print the file created by the user terminal 130a is described as an example.

After transmitting the print job from the user terminal 130a, the user A inputs an ID and a password to the image forming apparatus 110 as a login operation (Number 1). The image forming apparatus 110 receives the user's login operation and requests the server 120 for authentication (Number 2). When the image forming apparatus 110 fails to make an authentication request to the server 120 due to various reasons such as a communication failure, the server 120 does not make a response to the image forming apparatus 110. The authentication determination unit 312 of the image forming apparatus 110 determines that the authentication has failed (Number 3).

As described above, when the authentication determination unit 312 determines that the authentication has failed (Number 3), the authentication processing unit 313 of the image forming apparatus 110 starts the authentication process. In the authentication process executed by the image forming apparatus 110, the inquiry unit 314 first makes an inquiry request to the root image forming apparatus 110R (Number 4). In the inquiry request, the inquiry unit 314 transmits the ID input by the user A during the login operation to the root image forming apparatus 110R. In the example illustrated in FIG. 6, the inquiry unit 314 transmits the user A′s ID “0001”.

The inquiry unit 314 of the root image forming apparatus 110R transmits the received ID of the user A to each client terminal 130 included in the printing system 100 and makes an inquiry (Number 5).

In response to receiving the ID from the root image forming apparatus 110R, the inquiry response unit 331 of each client terminal 130 refers to the ID storage area of the terminal information storage unit 332. Then, the received ID is compared with the ID stored in the terminal information storage unit 332, and if the IDs match, the inquiry response unit 331 responds to the root image forming apparatus 110R (Number 6).

In the example illustrated in FIG. 6, the user terminal 130a stores the user A's ID “0001” in the terminal information storage unit 332. Accordingly, the user terminal 130a transmits the password “aaaa” for the user A to log in to the root image forming apparatus 110R. On the other hand, since the ID “0001” is not stored in the terminal information storage unit 332 of the other user terminals 130b and 130c, the inquiry response units 331 of the other user terminals 130b and 130c do not respond to the inquiry from the root image forming apparatus 110R.

Upon receiving the response from the user terminal 130a, the root image forming apparatus 110R notifies the image forming apparatus 110 of the acquired password (Number 7). As a result, the authentication processing unit 313 of the image forming apparatus 110 authenticates the user while reducing the load on the network even when communication with the server 120 is broken (Number 8). Further, the image forming apparatus 110 establishes communication between the image forming apparatus 110 and the user terminal 130a after the user is authenticated by acquiring the IP address of the user terminal 130a (Number 8). As a result, the user can perform the pull print process because the user can communicate with the user terminal 130a after logging in to the printing system 100.

In the first embodiment and the second embodiment described above, the image forming apparatus 110 executes the authentication process, but another configuration may be used. For example, as in a third embodiment described below, the user terminal 130a may perform the authentication process. The third embodiment is described below.

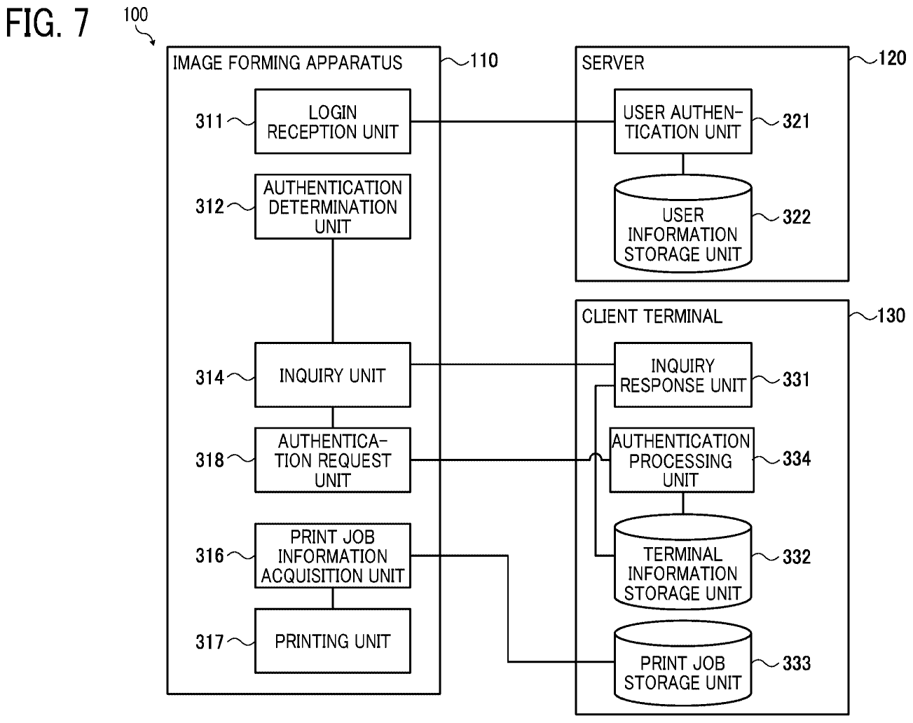

FIG. 7 is a block diagram illustrating a functional configuration of the printing system 100 according to the third embodiment of the present disclosure. Note that in FIG. 7, description common to the description of FIG. 3 is omitted.

First, a functional configuration of the image forming apparatus 110 is described. The image forming apparatus 110 included in the printing system 100 according to the third embodiment includes a login reception unit 311, an authentication determination unit 312, an inquiry unit 314, an authentication request unit 318, a print job information acquisition unit 316, and a printing unit 317. The description of the login reception unit 311, the authentication determination unit 312, the inquiry unit 314, the print job information acquisition unit 316, and the printing unit 317 are the same as the description of FIG. 3.

The authentication request unit 318 requests the user terminal 130a that has responded to the inquiry from the inquiry unit 314 to execute an authentication process. In response to receiving a response from the user terminal 130a by the inquiry unit 314, the authentication request unit 318 requests authentication by transmitting the password input by the user to the user terminal 130a.

Next, a description is given of functions of the client terminal 130. The client terminal 130 included in the printing system 100 according to the third embodiment includes an inquiry response unit 331, an authentication processing unit 334, a terminal information storage unit 332, and a print job storage unit 333. The description of inquiry response unit 331, the authentication processing unit 334, the terminal information storage unit 332, and the print job storage unit 333 are the same as the description of FIG. 3.

The authentication processing unit 334 executes the authentication process instead of the authentication unit of the server 120 like the authentication processing unit 313 included in the image forming apparatus 110 according to the first embodiment. Upon receiving the authentication request from the authentication request unit 318 of the image forming apparatus 110, the authentication processing unit 334 refers to the terminal information storage unit 332, and authenticates the user based on whether the ID and password received from the image forming apparatus 110 match the ID and password stored in the terminal information storage unit 332.

Next, a description is given of functions of the server 120. The server 120 included in the printing system 100 of the third embodiment includes a user authentication unit 321 and a user information storage unit 322. Since the server 120 in the third embodiment has the same configuration as the server 120 in the first embodiment, detailed description is omitted here.

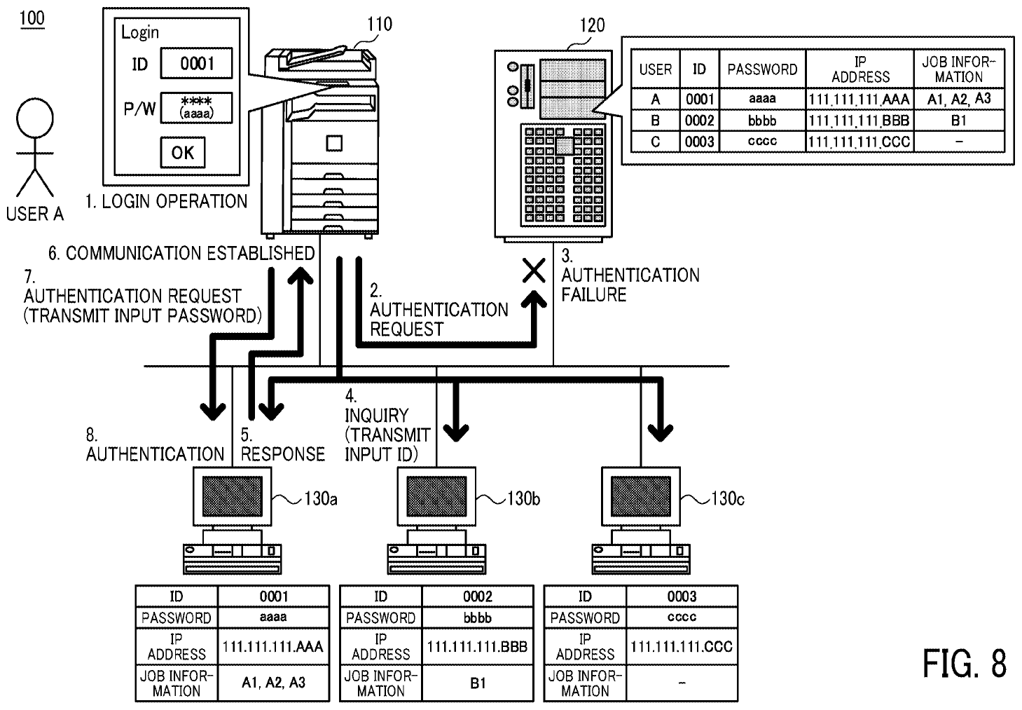

Next, an authentication process executed in the third embodiment is described. FIG. 8 is a diagram illustrating an authentication process executed by the printing system 100 according to the third embodiment of the present disclosure. The numbers in FIG. 8 indicate the order of processing. Further, in FIG. 8, description of items common to the items of the first embodiment described in FIG. 4 is omitted.

As illustrated in FIG. 8, the printing system 100 according to the third embodiment includes an image forming apparatus 110 configured to execute printing by the pull print method, the server 120 configured to authenticate a user, and a plurality of client terminals 130. Number 1 to Number 3 are the same as the processing in the first embodiment described with reference to FIG. 4, and detailed description is omitted here.

When the authentication determination unit 312 determines that the authentication has failed (Number 3), the inquiry unit 314 of the image forming apparatus 110 makes an inquiry to the plurality of client terminals 130 included in the printing system 100 (Number 4). Specifically, the inquiry unit 314 transmits the ID input by the user A during the login operation to the plurality of client terminals 130. In the example illustrated in FIG. 4, the inquiry unit 314 sends the user A′s ID “0001” to the user terminal 130a and the other user terminals 130b and 130c.

When the plurality of client terminals 130 included in the printing system 100 receive the ID from the image forming apparatus 110, the inquiry response unit 331 of each client terminal 130 refers to the storage area of the ID of the respective terminal information storage units 332. Then, at each client terminal 130, the inquiry response unit 331 compares the received ID with the ID stored in the terminal information storage unit 332, and if IDs match, responds to the image forming apparatus 110 (Number 5). When the received ID matches with the ID stored in the terminal information storage unit 332, the inquiry response unit 331 transmits the password corresponding to the ID to the image forming apparatus 110.

In response to receiving the response from the user terminal 130a, the image forming apparatus 110 establishes communication with the user terminal 130a based on the IP address (Number 6). Next, the authentication request unit 318 of the image forming apparatus 110 makes a user authentication request to the user terminal 130a (Number 7). In the example of FIG. 8, the authentication request unit 318 sends the authentication request and the password “aaaa” of the user A received by the login reception unit 311 of the image forming apparatus 110 to the user terminal 130a.

When the user terminal 130a receives the authentication request from the image forming apparatus 110, the authentication processing unit 334 executes an authentication process (Number 8). Specifically, the authentication processing unit 334 refers to the terminal information storage unit 332, and executes authentication depending on whether or not the stored password of the user A and the password transmitted together with the authentication request match.

In this way, by transmitting the password to the user terminal 130a that responded to the inquiry from the image forming apparatus 110, the authentication processing unit 334 collates with the password stored by the user terminal 130a to authenticate the user. Therefore, even when communication with the server 120 is broken, the user terminal 130a can authenticate the user, and the user can log in to the printing system 100.

In the third embodiment described with reference to FIG. 8, the authentication request is made after the communication is established, but the present disclosure is not limited to such a process. For example, in the case of a communication environment in which security is sufficiently secured, the ID and the password may be transmitted to the plurality of client terminals 130 at the time of the inquiry in the process of Number 4. As a result, the user terminal 130a can quickly execute the authentication process and can shorten the time until login.

For example, the second embodiment and the third embodiment may be combined and the root image forming apparatus 110R may request the user terminal 130a for authentication.

As described above, according to the embodiments of the present disclosure described above, it is possible to provide an information processing system, an information processing apparatus, a method, and a program that can authenticate a user even in a situation where communication with the authentication apparatus is broken.

Each function in the exemplary embodiment may be implemented by a program described in C, C++, C# or Java (registered trademark). The program may be provided using any storage medium that is readable by an apparatus, such as a hard disk drive, compact disc (CD) ROM, magneto-optical disc (MO), digital versatile disc (DVD), a flexible disc, erasable programmable read-only memory (EPROM), or electrically erasable PROM. Alternatively, the program may be transmitted through network such that other apparatus can receive the program.

The functional block in the above-described embodiment corresponds to a functional unit implemented by causing each hardware to function by the CPU 201 of each device executing the program of each embodiment. Further, all of the functional units described in each embodiment may be implemented by software, or part or all of functional units may be implemented as hardware that provides equivalent functions.

Furthermore, all of the functional units described above do not necessarily have to be included in the configurations illustrated in FIG. 3 and FIG. 7. For example, in another preferred embodiment, each functional unit may be implemented by cooperation of each device included in the printing system 100.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An information processing system comprising:
an authentication apparatus;
one or more terminals; and
an information processing apparatus, the information processing system comprising:
first circuitry configured to;
receive input of identification information and authentication information of a user; and
make an authentication request to the authentication apparatus; and
second circuitry configured to;
in response to a failure in authentication by the authentication apparatus, transmit to the one or more terminals, the identification information and an inquiry asking whether each terminal of the one or more terminals stores identification information that matches the identification information input by the user.

2. The information processing system of claim 1, wherein
the first circuitry is further configured to:
authenticate the user based on the authentication information received from a response terminal of the one or more terminals, the response terminal being configured to store identification information that matches the identification information and responds to the inquiry from the second circuitry.

3. The information processing system of claim 2, wherein
the information processing apparatus includes a first information processing apparatus and a second information processing apparatus, wherein
the first circuitry resides on the first information processing apparatus, and the second circuitry resides on the second information processing apparatus, and
in response to the failure in authentication by the authentication apparatus, the first circuitry is further configured to:
request the second circuitry to transmit the inquiry to the one or more terminals.

4. The information processing system of claim 1, wherein
the response terminal acquires the identification information and the authentication information from the information processing apparatus and authenticates the user.

5. The information processing system of claim 1, wherein
each one of the one or more terminals transmits an IP address of each terminal to the information processing apparatus.

6. The information processing system of claim 1, wherein
the first circuitry is further configured to acquire the IP address of the response terminal from the response terminal.

7. The information processing system of claim 6, wherein
the first circuitry is further configured to acquire print job information from the response terminal based on the IP address.

8. The information processing system of claim 7, wherein
the first circuitry is further configured to form an image based on print data related to the print job information.

9. An information processing apparatus communicably connected to an authentication apparatus configured to authenticate a user, and one or more terminals, the information processing apparatus comprising:
circuitry configured to;
make an authentication request to the authentication apparatus in response to receiving input of identification information and authentication information from the user;
in response to failure in the authentication by the authentication apparatus, transmit to the one or more terminals, the identification information and an inquiry asking whether each terminal of the one or more terminals stores identification information that matches the identification information input by the user; and
authenticate the user based on the authentication information received from a response terminal of the one or more terminals, the response terminal being configured to store identification information that matches the identification information and responds to the inquiry.

10. An information processing apparatus of claim 9 wherein
the circuitry is further configured to acquire an IP address of the response terminal from the response terminal.

11. An information processing apparatus of claim 10, wherein
the circuitry is further configured to acquire print job information from the response terminal based on the IP address.

12. An information processing apparatus of claim 11, wherein the circuitry is further configured to:
form an image based on print data related to the print job information.

13. An information processing apparatus of claim 9, wherein
the circuitry is further configured to:
transmit a public key for encryption together with the identification information;
decrypt the authentication information encrypted by the response terminal with the public key, using a secret key corresponding to the public key; and
authenticate the user based on the authentication information.

14. A user authentication method comprising:
receiving input of identification information and authentication information of a user;
making an authentication request to an authentication apparatus;
in response to failure in authentication by the authentication apparatus, transmitting to one or more terminals, the identification information and an inquiry asking whether each of the one or more terminals stores identification information that matches the identification information input by the user; and
authenticating the user based on authentication information received from a response terminal of the one or more terminals, the response terminal being configured to store identification information that matches the identification information and responds to the inquiry.

15. A non-transitory recording medium storing a plurality of instructions which, when executed by one or more processors, cause the processors to perform a user authentication method of claim 14.
